(19) United States
(12) Patent Application Publication
(10) Pub. No.: US 2006/0072551 A1
(43) Pub. Date: Apr. 6, 2006

(54) Information processing apparatus, management apparatus and network system

(75) Inventors: Motoaki Aoyama, Tokyo (JP); Shunichi Kumakura, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/127,276

(22) Filed: May 12, 2005

(30) Foreign Application Priority Data
Oct. 5, 2004 (JP) JP2004-292178

(51) Int. Cl. H04L 12/66

(52) U.S. Cl. 370/352

(57) ABSTRACT

The multifunction peripheral, which is the information processing apparatus, sends inquiries to the management apparatus of the setup location (hotspot) about the available services on the network. In response to this inquiry, the management apparatus notifies the multifunction peripheral of the available services, and the operation buttons for functions realized using the network services which were indicated to be unavailable by the notification are not displayed or grayed out by the multifunction peripheral and user selection operation for these functions is made impossible.

### RELATED APPLICATION

This application claims priority from Japanese Patent Application No. 2004-292178 filed Oct. 5, 2004, which is incorporated hereinto by reference.

### BACKGROUND

1. Field of the Invention

The present invention relates to user interface and security management in an information processing apparatus which uses services provided from a network.

2. Description of the Related Art

In a multifunction peripheral in which a scanner function, printer function, facsimile function and the like are integrated in a copier, the multifunction capabilities can be further advanced through connection to a network. For example, a transfer function or the like is equipped in which image data obtained by reading a document with the scanner function may be made into a file and transferred via the network.

In order to improve the convenience of using this type of multifunction peripheral, technology has been proposed in which, when the multifunction peripheral is not connected to the network, a “connection to network” display either disappears or is displayed pale (grayed out) (for example, Japanese Patent Application Laid-Open Publication No. 11-165456).

Note that in recent years, train stations, airports, stores and the like have wireless LAN (Local Area Network) base stations and, a network environment called a hotspot (registered trademark) is provided in which connection to the internet can be done from a personal computer or a portable information terminal in those service areas.

In addition, technology has been disclosed in which, in the case where confidential information is being sent to a mobile receiving terminal, the position of the receiving terminal is determined, and when the receiving terminal is in a network environment which may be used by an unspecified large number of users such as in a hotspot or the like, the server does not allow data to be sent to that receiving terminal and thereby ensures security. (See Japanese Patent Application Laid-Open Publication No. 2000-270014 for example.)

The type of network service (referred simply as service hereinafter) which can be received in a hotspot depends on the provider of the hotspot. Access to websites is generally provided, but depending on the hotspot, in some cases, services such as sending and receiving of electronic mail, file transferring, and file sharing with outside of the hotspot are not provided.

If a multifunction peripheral is set up in this type of environment, although these services are displayed on the operation menu of the multifunction peripheral, the desired services cannot be received from the network, and as a result some of the functions cannot be actually used. This problem is not solved by the Japanese Patent Application Laid-Open Publication No. 11-165456 in which a determination is only made as to whether there is connection to the network.

In addition, the security level is different between a company lobby and the like where leakage of confidential information is strictly limited and a public facility such a library or train station, and thus the functions which the user may use must be changed in accordance with the set up location of the multifunction peripheral. In Japanese Patent Application Laid-Open Publication No. 2000-270014, data transfer is not permitted in accordance with the position of the receiving terminal, and thus at a location where data transfer is not permitted, all functions involving data transfer cannot be used. For this reason, dividing the security level into multiple levels and gradually controlling the available functions is not possible.

Furthermore, there is the problem that when setting up the multifunction peripheral, a manager or a serviceperson must check the available services and security level and the like for the network environment in that set up location, and also do initialization settings of the function restricting for that multifunction peripheral. As a result, many operations are required, and in addition, these operations can only be performed by persons with expert knowledge.

### SUMMARY

In view of foregoing, an object of this invention is to solve at least one of the problems, and to provide an information processing apparatus having function relating to data transmission or data reception, which comprises a communication section connected to a management apparatus with a network, the management apparatus manages a service providing apparatus which provides a function relating to data transmission or data reception in the network, a display section which displays the function relating to data transmission or data reception of the information processing apparatus, and a control section which controls the communication section and the display section, wherein the control section controls the communication section to receive an available information or a non-available information with regard to an available function or a non-available function of the service providing apparatus in the network, and controls the display section so that an available function of the information processing apparatus is selectable or a non-available function thereof is not selectable based on the available information or the non-available information.

Another aspect of the invention is to provide an information processing apparatus having a function relating to data transmission or data reception, which comprises, a communication section connected to a management apparatus with a network, the management apparatus manages a service providing apparatus which provides a function relating to data transmission or data reception in the network, a display section which displays the function relating to data transmission or data reception of the information processing apparatus; and a control section which controls the communication section and the display section, wherein the control section controls the communication section to receive a security information of the network from the management apparatus, judges an available function relating to data transmission or data reception of the information processing apparatus and controls the display section so that an available function of the information processing apparatus is selectable or a non-available function thereof is not selectable based on the judgment.

And a further aspect of the invention is to provide an information processing apparatus having a function relating to data transmission or data reception, which comprises, a communication section connected to a service providing apparatus which provides a function relating to data transmission or data reception in the network with a network, a display section which displays the function relating to data transmission or data reception of the information processing apparatus, and a control section which controls the communication section and the display section, wherein the control section controls the communication section to receive an available information or a non-available information with regard to an available function or a non-available function of the service providing apparatus in the network, and controls the display section so that an available function of the information processing apparatus is selectable or a non-available function thereof is not selectable based on the available information or the non-available information.

Another aspect of the invention is to provide management apparatus for managing a service providing apparatus which provides a function relating to data transmission or data reception in the network, the management apparatus is connected with an information processing apparatus including a display section which displays a function relating to data transmission or data reception of the information processing apparatus, and a control section which controls the display section so that an available function of the information processing apparatus is selectable or a non-available function thereof is not selectable based on an information or a non-available information, comprises a communication section connected to the information processing apparatus with a network, and a control section which controls the communication section to send the available information or the non-available information with regard to an available function or a non-available function of the service providing apparatus in the network in response to a request from the information processing apparatus.

And yet another aspect of the invention is to provide management apparatus for managing a service providing apparatus which provides a function relating to data transmission or data reception in the network, the management apparatus is connected with an information processing apparatus including a display section which displays a function relating to data transmission or data reception of the information processing apparatus, and a control section which controls the display section so that an available function of the information processing apparatus is selectable or a non-available function thereof is not selectable based on a security information the network, comprises a communication section connected to the information processing apparatus with a network, and an control section which controls the communication section to send the security information of the network in response to a request from the information processing apparatus.

And a further aspect of the invention is to provide a network system, comprises, an information processing apparatus which has a function relating to data transmission or data reception, and a management apparatus which manages a service providing apparatus providing a function relating to data transmission or data reception in the network, wherein the information processing apparatus comprises a first communication section connected to the management apparatus with a network, a display section which displays the function relating to data transmission or data reception of the information processing apparatus; and a first control section which controls the first communication section and the display section, wherein the first control section controls the first communication section to receive an available information or a non-available information with regard to an available function or a non-available function of the service providing apparatus in the network, and controls the display section so that an available function of the information processing apparatus is selectable or a non-available function thereof is not selectable based on the available information or the non-available information, wherein the management apparatus comprises a second communication section connected to the information processing apparatus with a network; and a second control section which controls the second communication section to send the available information or the non-available information in response to a request from the information processing apparatus.

And a still further aspect of the invention is to provide a network system, comprises an information processing apparatus which has a function relating to data transmission or data reception, and a management apparatus which manages a service providing apparatus providing a function relating to data transmission or data reception in the network, wherein the information processing apparatus comprises a first communication section connected to the management apparatus with a network, a display section which displays the function relating to data transmission or data reception of the information processing apparatus; and a first control section which controls the first communication section and the display section, wherein the first control section controls the first communication section to receive a security information of the network from the management apparatus, judges an available function relating to data transmission or data reception of the information processing apparatus and controls the display section so that an available function of the information processing apparatus is selectable or a non-available function thereof is not selectable based on the judgment, wherein the management apparatus comprises a second communication section connected to the information processing apparatus with a network; and a second control section which controls the second communication section to send the security information of the network in response to a request from the information processing apparatus.

The invention itself, together with further objects and attendant advantages, will best be understood by reference to the following detailed description taken in conjunction with the accompanying drawings.

### BRIEF DESCRIPTION OF THE DRAWINGS

FIG. 1 is an explanatory view of an example of the network structure including the hotspot used in the network system of the first embodiment.

FIG. 2 is a block diagram showing the structure of the multifunction peripheral as the information processing apparatus that is set up in the hotspot shown in FIG. 1.

FIG. 3 is a block diagram showing the structure of the management apparatus of FIG. 1.

FIG. 4 is an explanatory diagram showing an example of the registration table.

FIG. 5 is a flowchart showing the operations for function restricting of the multifunction peripheral and the management apparatus.

FIG. 6 is an explanatory diagram showing an example of the interchange for service inquiry and notification in the hotspot used in the management apparatus and the access states after function restricting.

FIG. 7 is an explanatory diagram showing an example of the operations screen displayed on the multifunction peripheral set up in the hotspot in FIG. 1.

FIG. 8 is an explanatory diagram showing an example of the operations screen displayed on the multifunction peripheral set up in the hotspot in FIG. 1.

FIG. 9 is an explanatory diagram showing an example of an operation screen in which the selection buttons for unavailable functions are grayed out.

FIG. 10 is an explanatory diagram of an example of an operation screen in which the functions are selected using a tab system.

FIG. 11 is an explanatory diagram of an example of an operation screen in which the tabs for the functions which are unavailable are not displayed.

FIG. 12 is a block diagram showing the management apparatus of the network system of the second embodiment.

FIG. 13 is a flowchart showing the process procedure in the management apparatus of FIG. 12.

FIG. 14 is an explanatory diagram showing an example of the access state when the management apparatus checks the services which can be provided and an example of the interchange for inquiry and notification about services which can be provided.

FIG. 15 is a block diagram showing the structure of the multifunction peripheral of the third embodiment.

FIG. 16 is a flowchart showing the process for function restricting performed by the multifunction peripheral of FIG. 15.

FIG. 17 is an explanatory diagram showing an example of the access state when the multifunction peripheral of FIG. 15 checks the services that can be provided.

In the following description, like parts are designated by like reference numbers throughout the several drawings.

### DESCRIPTION OF THE PREFERRED EMBODIMENT

The embodiments of this invention will be described based on the drawings.

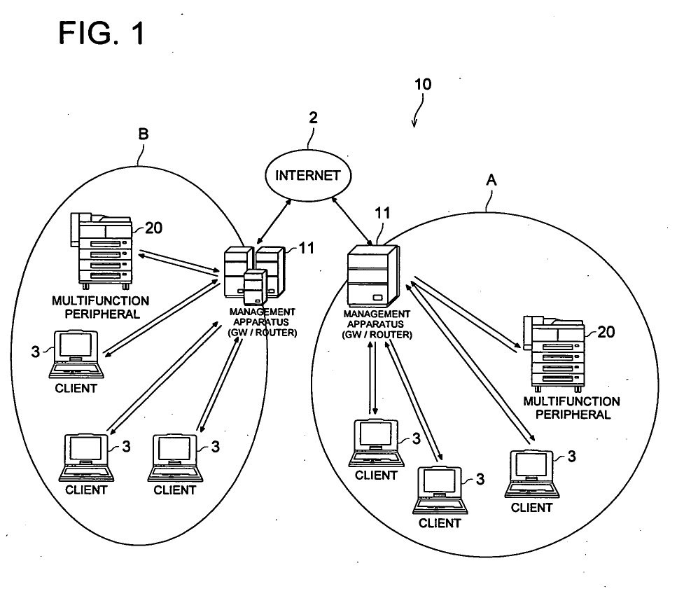

FIG. 1 is an example of the network structure including the hotspot used in the network system 10 of the first embodiment. A hotspot is a place where a LAN is provided at train station, airport, store or the like and an unspecified number of users connect to the LAN with their own personal computers or with mobile information terminals to access the internet. A wireless LAN is generally used in hotspots.

In FIG. 1, a plurality of management apparatuses 11 are connected to the internet 2. One of the management apparatuses 11 forms the hotspot A, and another of the management apparatuses 11 forms the hotspot B. The management apparatuses 11 function as the wireless LAN base station and also function as a gateway or router for connecting the LAN in the hotspot with the external internet 2.

Clients 3 such as a multifunction peripheral 20, a personal computer, or mobile information terminal are connected as the information processing apparatus to the hotspots A and B via a wireless LAN.

The types of network services which are available in the hotspot vary depending on the hotspot. In hotspot B, shown in FIG. 1, network services such as electronic mail FTP (file transfer protocol), SMB (Server Message Block) and the like can be received. On the other hand, in hotspot A, electronic mail can be used, but FTP and SMB cannot be used.

It is to be noted that FTP is a protocol used when transferring file via the internet and SMB is a protocol for realizing file sharing and printer sharing through a network. By restricting use of FTP and SMB, the data that can be transferred from inside the hotspot to the outside is restricted and security can be thereby increased.

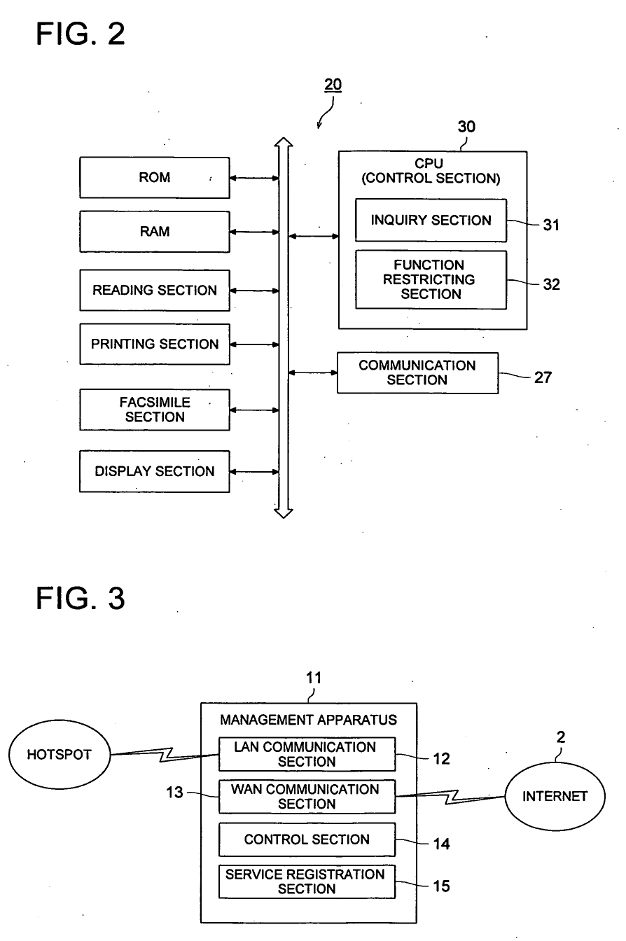

FIG. 2 shows the structure of the multifunction peripheral 20 as the information processing apparatus. The multifunction peripheral 20 is an image processing device including scanner function for reading document images, copy function reading the document image and forming the duplicated image on recording paper, a printer function for forming images corresponding to the printing data on recording paper, a facsimile function for sending and receiving document images, and a transfer function for sending image data to an external device using electronic mail, FTP or SMB.

The multifunction peripheral 20 comprises a CPU (central processing unit) 30 as the control section for performing central control of the operations, a ROM (read only memory) 21, and RAM (random access memory) 22 as circuits which are the main parts. The ROM 21 stores the programs executed by the CPU 30 and various fixed data. The RAM 22 functions as a work memory for temporarily storing various data when the CPU executes programs or as a page memory for storing at least one page of image data for performing the rotating process and the like.

The reading section 23 reads the document images to obtain image data corresponding to the document images. The reading section 23 comprises a light source which irradiates documents; a line image sensor which reads one line portions of the document in the width direction thereof; a moving section which moves the reading position of the line unit in the longitudinal direction of the document; and an optical path formed of lens and mirrors which lead the light reflected from the document to the line image sensor and focuses it. The line image sensor comprises of a CCD (charge coupled device). The analog image signals that the line image sensor outputs is A/D converted and taken in as digital image data.

The printer section 24 carries out the function of forming images corresponding to the image data on recording paper by using an electro photographic process. The printer section 24 comprises a recording paper conveying device, a photoreceptor drum, a charging device, a laser unit, a developing device, a transfer and separation device, a cleaning device, and a fixing device and is formed as a laser printer. The facsimile section 25 is a section which functions as a facsimile. It performs the compression and decompression function in a compression system of image data corresponding to a facsimile and controls the communications procedure for and facsimile sending and receiving.

The display section 26 comprises a liquid crystal display including a touch panel on the surface and various operation switches. The display section 26 shows various information displays and status displays to the user and functions as an operation section which receives operations for function selection or other operations from the user. The communication section 27 connects with networks such as the wireless LAN and the like or telephone lines and communicates with external devices.

In addition to performing central control of the operations of multifunction peripheral 20, the CPU 30 also functions as the inquiry section 31 and the function restricting section 32. The inquiry section 31 sends inquiries to the management apparatus of the connected network about the services available on that network. The function restricting section 32 restricts the functions that are selectable by the user at the display section 26 based on the results of the inquiry by the inquiry section 31. More specifically, display of the operation section for the functions realized by using services that are not available on the connected network are erased or displayed so that operation is impossible (grayed out).

FIG. 3 shows the structure of the management apparatus 11. The management apparatus 11 comprises: a LAN communication section 12 which plays the role of a base station for the LAN which forms the hotspot; a WAN communication section 13 for communicating with the internet 2 which is a wide area network; a control section 14 for central control of the management apparatus 11 and performing processes corresponding to inquiries from the multifunction peripheral 20; and a service registration section 15 which stores in memory the services available at the hotspot (LAN side network) being managed.

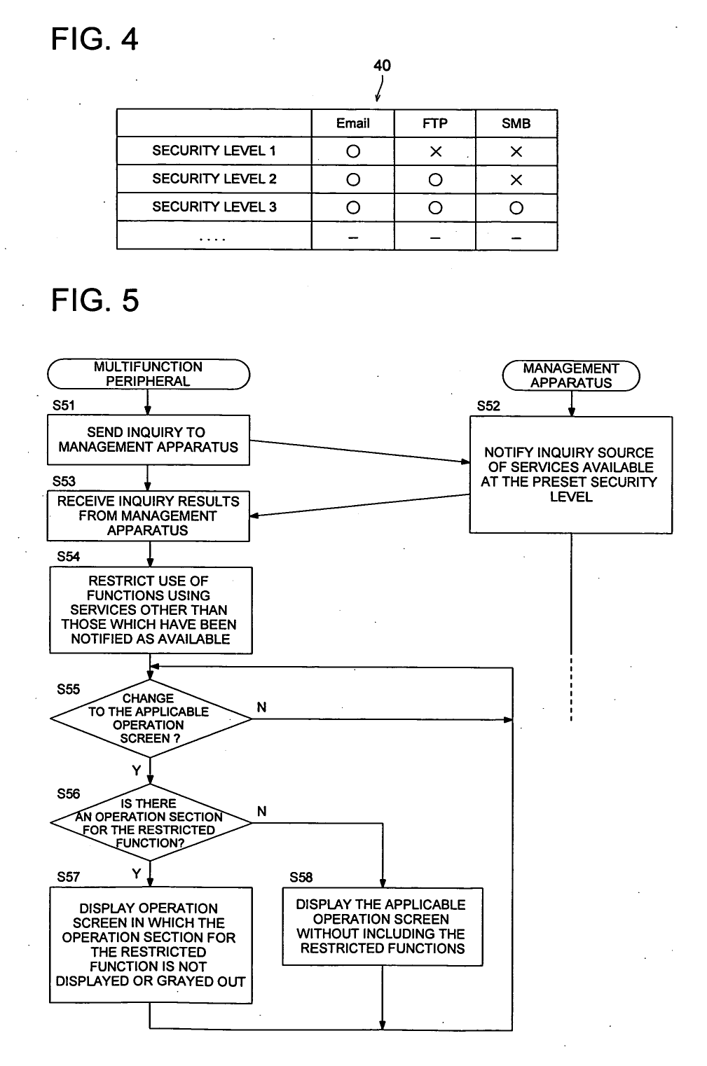

FIG. 4 is an example of the registration table 40 which is stored in the service registration section 15. The registration table 40 registers whether the services are available for each security level. The circle in the drawing indicates that the service is available while x indicates that it is unavailable. At security level 1, electronic mail (e-mail) is available, but FTP and SMB are unavailable. At security level 2, electronic mail and FTP are available, but SMB is unavailable. At security level 3, electronic mail, FTP and SMB are available.

One of the security levels for the management apparatus 11 is registered at the service registration section 15. The services that can be provided in this security level are specified with reference to the registration table 40. The security level can be set remotely via the network or may be set with the operation section or switch setting of the management apparatus 11.

FIG. 5 shows the operation for function restricting of the multifunction peripheral 20 and the management apparatus 11. The multifunction peripheral 20 sends inquires to the management apparatus 11 of the connected network about the services that can be provided on this network using the communication section 27 (Step S51). The management apparatus 11 which receives the inquiry reads the available services at the pre-set security level from the service registration section 15 and notifies the multifunction peripheral 20 which is the source of the inquiry (Step S52).

The multifunction peripheral 20 receives the notification of the results of the inquiry (Step S53), and in terms of functions realized by using the services which are not indicated to be available based on this notification (unavailable services), setting for the multifunction peripheral 20 is done so that usage for those functions is not allowed (Step S54). For example, whether a particular function is available or not is set in the function manager table in which availability or unavailability is recorded for each function.

Subsequently, when a user operation is performed for changing the operation screen for the function realized by using the service provided from the network (Y in Step S55), a check is done to determine whether the functions set as unavailable in the functions displayed by the operation section in the operation screen (Step S56.) When there are functions set to be unavailable among the functions in the operations section (Y in Step S56), an operation screen is displayed in which the operation section for the corresponding function is not displayed or displayed in a form such that it cannot be operated (Step S57).

When there are no functions set to be unavailable among the functions of the operation screen (N in Step S56), an operation screen is displayed in which the operation sections for the all the functions to be displayed in this operation screen are displayed (Step S58). After the operation screen is displayed in Step S57 or Step S58, the procedure returns to Step S55 and the above processes are repeated.

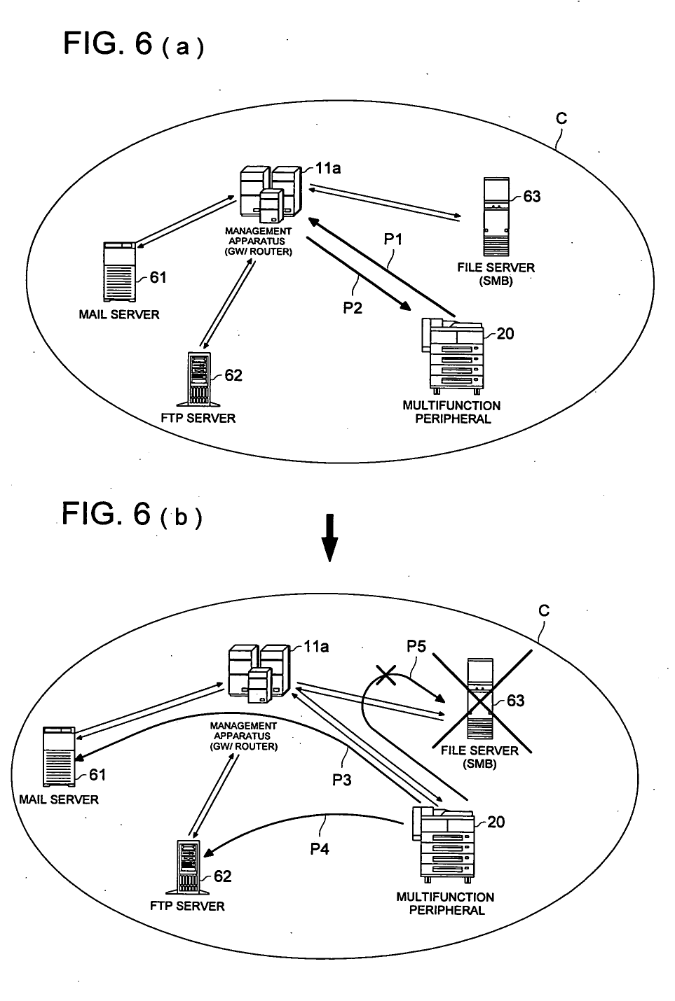

FIG. 6(a) shows the correspondences for service inquiry and notification in the hotspot used in the management apparatus 11 and FIG. 6(b) the state in which available functions of the multifunction peripheral 20 are restricted in accordance with the results of the inquiry.

The hotspot C has a mail server 61, an FTP server 62, and an SMB server 63 connected, and electronic mail, FTP and SMB network services can be provided. However, because hotspot C is set to security level 2, when an inquiry about available services is sent by the multifunction peripheral 20 to the management apparatus 11a (FIG. 6(a), P1), a notification is sent that the available services are electronic mail and FTP (P2).

As shown in FIG. 6(b), the multifunction peripheral 20 is set such that the mail server 61 and the FTP server 62 are available, and the SMB server 63 is unavailable. For example, when a read document is transferred to an external device, the function for sending the document as an attachment to electronic mail (P3) and the function for sending the document with FTP (P4) may be used while the function of sending the document using SMB (P5) may not be used.

It is to be noted that in the case where the relationship between the security level and the services that are available at that security level is defined in common at the multifunction peripheral 20 and the management apparatus 11, the multifunction peripheral 20 is notified of the security level as the results of the inquiry, and a determination for whether the services are available or not is made at the multifunction peripheral 20 side based on security level which is sent from the management apparatus 11.

It is to be noted that in the case where security level 3 is set at the management apparatus 11, notification that electronic mail, FTP and SMB are available services is sent in response to the inquiry from the multifunction peripheral 20. In addition, in the case where the security level 1 is set at the management apparatus, notification that only electronic mail is an available service is sent in response to the inquiry from the multifunction peripheral 20.

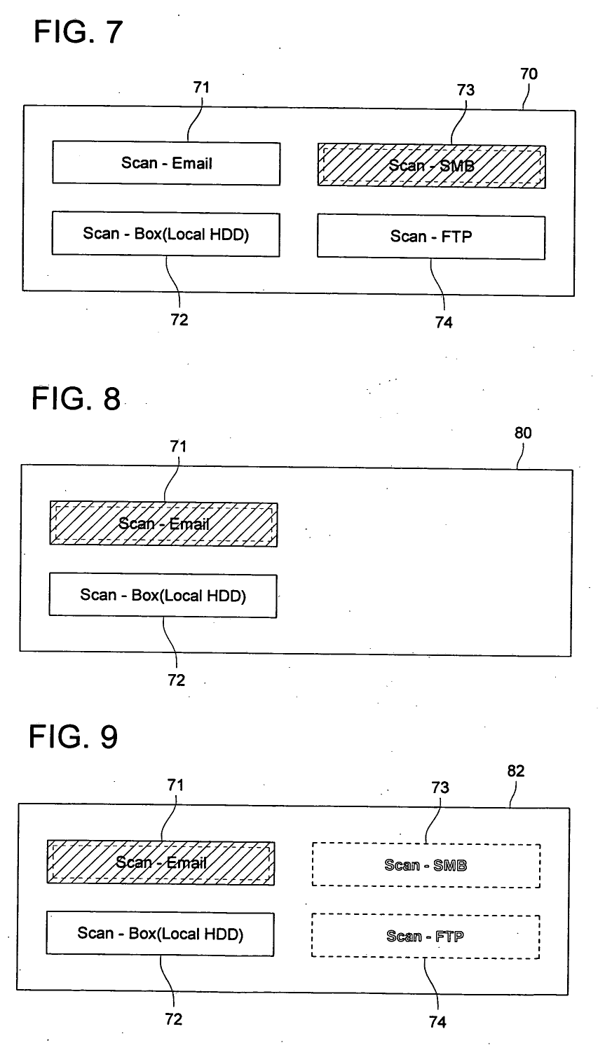

FIG. 7 shows an example of the operations screen 70 displayed on the multifunction peripheral 20 set up in the hotspot B in FIG. 1. In the hotspot B, security level 3 is set, and electronic mail, FTP and SMB service can all be available. As a result, the ‘Scan-Email’ button 71, the ‘Scan-Box (Local HDD)’ button 72, the ‘Scan-SMB’ button 73, the ‘Scan-FTP’ button 74 are all displayed as the function selection buttons at the operations screen 70.

The ‘Scan-Email’ button 71 is a function selection button, in this function, the document is read at the reading section 23 and the image data is transferred as an attachment to electronic mail. The ‘Scan-Box (Local HDD)’ button 72 is a function selection button, in this function, the document is read at the reading section 23 and the image data is stored in the built in hard disk device. The ‘Scan-SMB’ button 73 is a function selection button, in this function, the document is read at the reading section 23 and the image data is transferred using SMB. The ‘Scan-FTP’ button 74 is a function selection button, in this function, the document is read at the reading section 23 and the image data is transferred using FTP. In the drawing, the button in the selected state is shown by diagonal lines. FIG. 7 shows the state where the ‘Scan-SMB’ button 73 has been selected.

FIG. 8 shows an example of the operation screen 80 displayed on the multifunction peripheral 20 set up in the hotspot A shown in FIG. 1. In the hotspot A, the security level 1 is set and electronic mail can be used, but FTP and SMB cannot be used. As a result, the ‘Scan-Email’ button 71, and the ‘Scan-Box (Local HDD)’ button 72 are displayed as function selection buttons at the operation screen 80 but the ‘Scan-SMB’ button 73 and the ‘Scan-FTP’ button 74 as shown in the operation screen 70 of FIG. 7 are not displayed.

FIG. 9 shows an example of an operation screen in which the selection buttons for functions which cannot be used are grayed out such that operation is impossible rather than not displayed. The ‘Scan-SMB’ button 73 and the ‘Scan-FTP’ button 74 for functions which cannot be used are displayed pale (or grayed out) when compared to the ‘Scan-Email’ button 71 and the ‘Scan-Box (Local HDD)’ button 72 for functions that are available. By displaying the selection buttons to be pale, the user is aware that the functions corresponding to the selection buttons 73 and 74 exist in the multifunction peripheral 20, but those functions cannot be used at the present time and that operation of the selection buttons 73 and 74 is impossible.

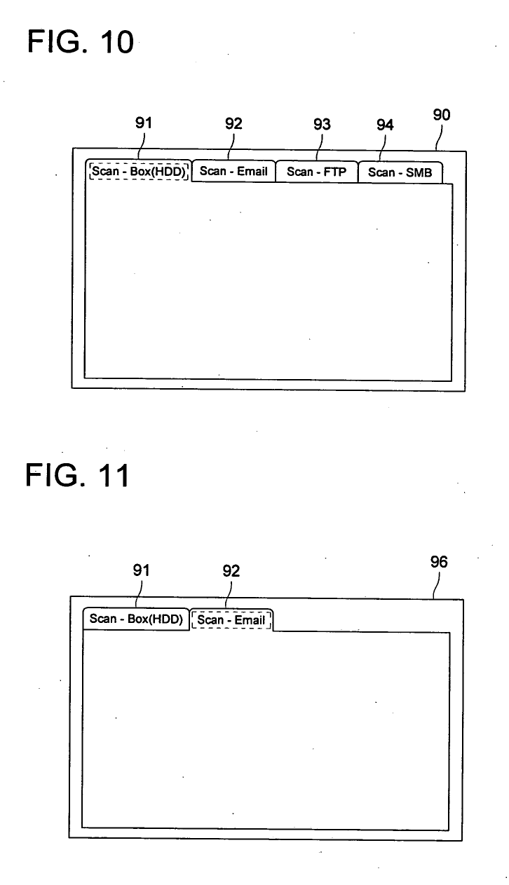

FIG. 10 is an example of the operation screen 90 in which the functions are selected using a tab system. By the user touching the applicable tab, the set screen for the functions corresponding to that tab is displayed. FIG. 10 is the operations screen 90 for the case where electronic mail, FTP, and SMB services are all available, and ‘Scan-Box (HDD)’ tab 91, ‘Scan-Email’ tab 92, the ‘Scan-FTP’ tab 93 and the ‘Scan-SMB’ tab 94 are displayed.

FIG. 11 shows the operation screen 96 for the case in which FTB and SMB cannot be used. Only the ‘Scan-Box (HDD)’ tab 91 and ‘Scan-Email’ tab 92 are displayed, and tabs for the functions that cannot be used are not displayed. In FIG. 11, the ‘Scan-FTP’ tab 93 and the ‘Scan-SMB’ tab 94 are not displayed.

In this manner, because user function selection is automatically limited in accordance with the available services, operation buttons for unavailable functions are not displayed or are displayed pale and so the user is not misled, and convenience and operation properties are thereby improved. Furthermore, there is no need for a serviceperson or manager to check the available services in the network environment of the set up location and perform initializations settings for restricting the functions selectable by the user, and thus the operational load at the time of set up is lightened.

Next, the second embodiment of this invention will be described.

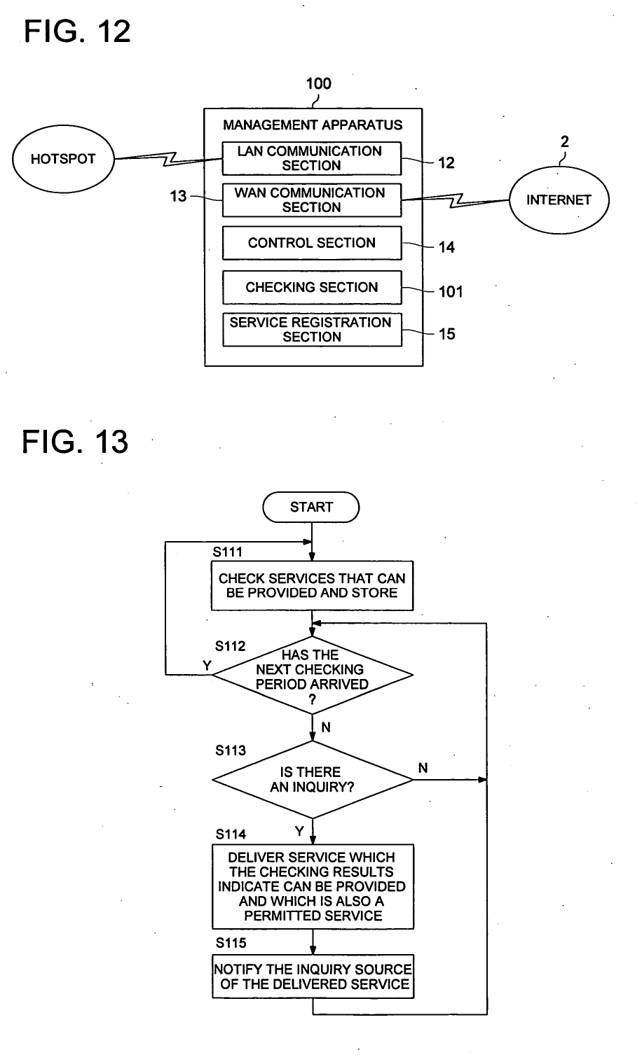

FIG. 12 shows the structure of the management apparatus 100 of the network system of the second embodiment. It differs from the management apparatus 11 shown in FIG. 3 in that it has a checking section 101. The parts that are the same as the management apparatus 11 of FIG. 3 have been assigned the same numbers and descriptions thereof have been omitted. The checking section 101 performs the function of checking what services that can be provided (checking whether service providing devices such as a mail server, an FTP server, an SMB server are connected to the network and whether the devices are in a ready state and capable of providing service) from the hotspot (LAN side network) for the information processing apparatus within that area.

For example, the checking section 101 checks whether servers such as a mail server, an FTP server, an SMB server and the like are available. At this time, the methods for checking are the method for checking all the IP addresses of the servers in the network group where the management apparatus 100 is on and a method for checking the IP address for the server preset in the management apparatus 100 and checking whether the service is available only for the preset IP address. In the former case, the network group where the management apparatus 100 is on can be recognized by a subnet mask. In the later case, the server is to be checked is restricted, so time required for checking is reduced.

A PING (Packet Internet Groper) can be used for the checking. Also the port number may be specified, and a check is done to determine whether there is a specific type of server at that address.

FIG. 13 shows the process procedure of the management apparatus 100. First the services that can be provided from the network are checked using the above checking method, and the results of the checking are stored in a memory section that is not shown (Step S111). The checking is repeated at a preset period and this is used to update the content of memory in the memory section (Y in Step S112).

When there is an inquiry from the multifunction peripheral 20 about available services (N in Step S112, Y in Step S113), if the service is determined to be a service that can be provided and is stored in the memory section, and also use is permitted by the set security level (Step S114), notification is sent to the multifunction peripheral 20 which is the source of the inquiry about the service (Step S115). In other words, the services notified to the multifunction peripheral 20 are determined by based on the checking results and the security level.

For example, in the case where the results of the checking show that electronic mail and FTP can be provided and the set security level is 1, because use of electronic mail is permitted but use of FTP is not permitted at security level 1, the multifunction peripheral 20 is notified that the only available service is electronic mail.

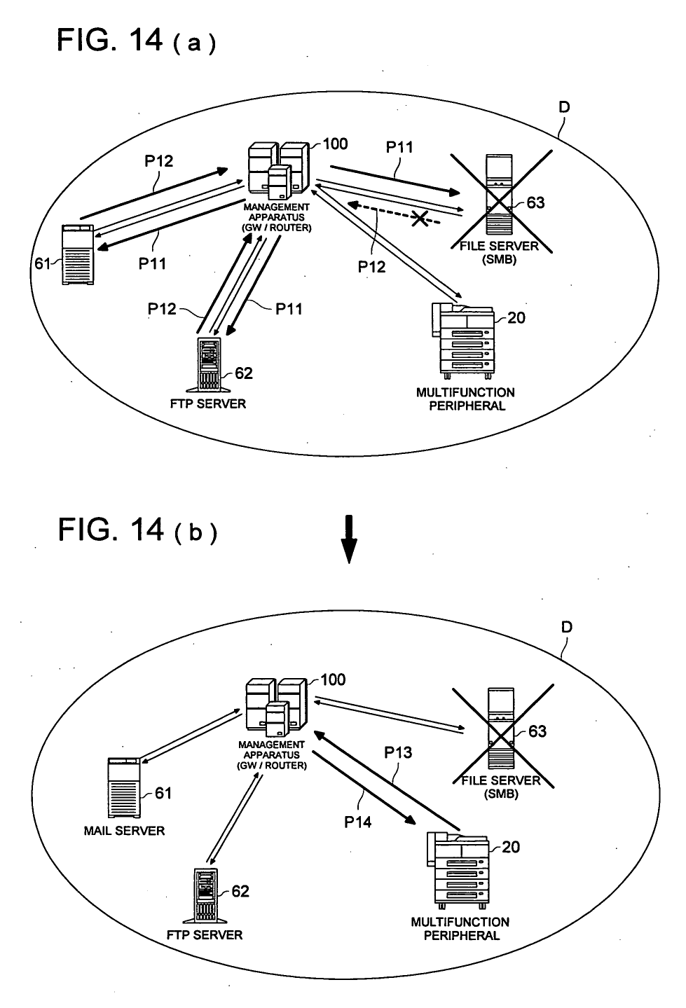

FIG. 14(a) shows an example of the access state when the management apparatus 100 checks services that can be provided. The management apparatus 100 accesses preset IP addresses (P11) and a determination is made as to whether service provided by each of the IP addresses is available based on whether there is a response (P12) or on the content of the response. In the example of FIG. 14(a), there is a response indicating that access from the mail server 61 and the FTP server 62 is possible and there is no response from the SMB server 63. As a result, the management apparatus 100 recognizes that the mail server 61 and the FTP server 62 are available and the SMB server 63 is not available.

FIG. 14(b) shows the interaction for inquiry about the services that can be provided and notification thereof. When there is an inquiry about available services from the multifunction peripheral 20 (P13), the multifunction peripheral 20 is notified of the available services by the management apparatus 100 based on the results of the previous checking (P14).

It is to be noted that in this example, the checking results notify as available, only services for which there is indication that the service can be provided, and for which use is permitted by the set security level, but the structure may be such that regardless of the security level, notification is given to the source of the inquiry that all services are available if the checking results (a capability information for a service to be provided of the service providing device) indicate that the service can be provided. Also, the content of the notification may change in accordance with the functions that information processing apparatus, which is the source of the inquiry about available functions, has.

Next the third embodiment of this invention will be described.

In the third embodiment, the multifunction peripheral itself checks the available services on the connected network.

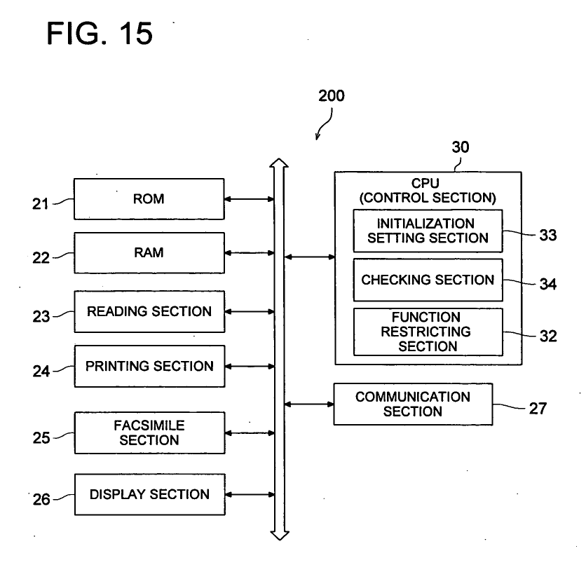

FIG. 15 shows the schematic structure of the multifunction peripheral 200 of the third embodiment. The multifunction peripheral 200 differs from the multifunction peripheral 20 shown in FIG. 2 in that the CPU 30 does not have the function of the inquiry section 31 while it has the functions of the initialization setting section 33 and the checking section 34. Aside from this, the structures are the same as those shown in FIG. 2 and descriptions thereof have been omitted.

The initialization setting section 33 functions as a setting section for receiving the security level settings. The structure may be such that setting whether use is permitted for each service is done rather than setting the security levels. The setting by the initialization setting section 33 should be limited only to people that have the authority of a manager. The checking section 34 performs the function of checking the available services on the network to which the multifunction peripheral 200 is connected. The methods for checking are the same as those used in the checking section 101 of the management apparatus 100 shown in the second embodiment.

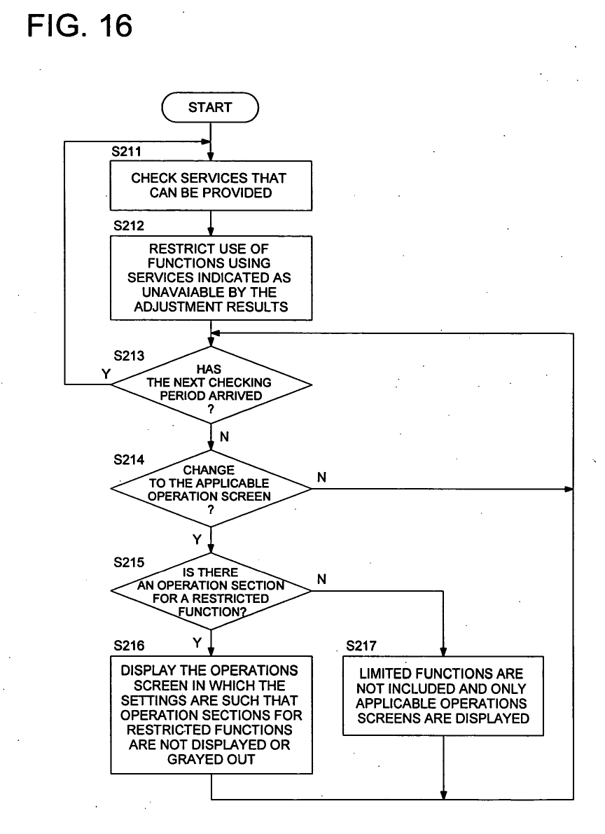

FIG. 16 shows a flowchart of the processes for function restricting performed by the management apparatus 100. First, the available services on the connected network are checked (Step S211), and setting is done so that use of functions realized using the services indicated as unavailable by the adjustment results is not permitted (Step S212). The checking is repeated at a preset period and this is used to update the content of memory in the memory section (Y in Step S213).

Subsequently, when a user operation is performed for changing to the operation screen for functions realized using the network service (Y in Step S214), checking is done to determine whether there are functions set as unavailable among the functions to be displayed by the operations sections on the operation screen (Step S215). If there are functions that are set as unavailable (Y in Step S215), an operation screen is displayed in which the operations sections for the function are not displayed or displayed in an inoperable state (Step S216). If there are no functions that are set as unavailable among the function displayed by the operations sections on the operation screen (N in Step S215), an operation screen is displayed in which the operations sections for all the functions to be displayed on the operations screen are shown (Step S217). After the operation screen is displayed in Step S216 or Step S217, the procedure returns to Step S213 and the above processes are repeated.

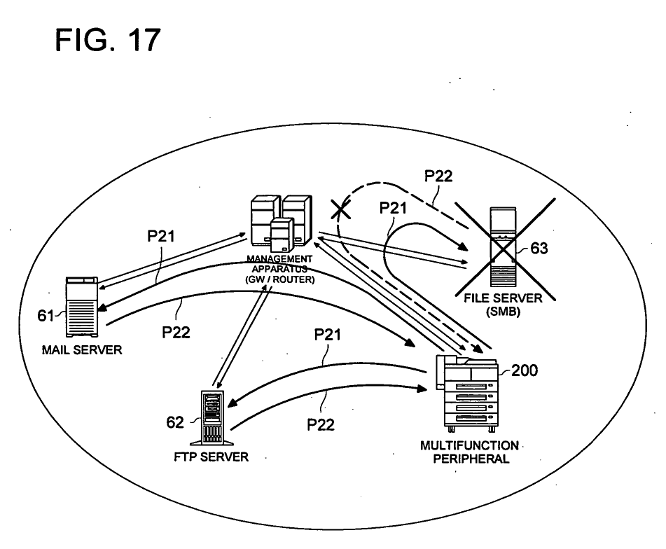

FIG. 17 shows an example of the access state when the multifunction peripheral 200 checks services that can be provided. The multifunction peripheral 200 accesses preset IP addresses (P21) and a determination is made as to whether servers provided by each of the IP addresses is available based on whether there is a response (P22) or on the content of the response. In the example of FIG. 17, there is a response indicating that access from the mail server 61 and the FTP server 62 is possible and there is no response from the SMB server 63, and thus it is recognized that the mail server 61 and the FTP server 62 are available and the SMB server 63 is not available.

It is to be noted that the structure may be such that only the services which are indicated as available by the result of the checking and for which use has been permitted by the initialization setting section 33 are available, and all other services are treated as unavailable. The security level of the multifunction peripheral 200 may be changed by details determining whether use of a function is permitted.

The embodiments have been described using drawings, but the specific structures are not to be limited by those shown in these embodiments, and modifications and additions which do not depart from the scope of this invention are included in this invention.

For example, the structure may be such that determining whether a service can be provided is done only for services using functions that the multifunction peripheral has by sending an inquiry to the management apparatus 11 or by the checking by the multifunction peripheral itself. As a result the processing time required for checking and notification is reduced.

In addition, in these embodiments, the management apparatus functions a gateway or router, but the management apparatus may be any device which gives notification of available services in response to inquiries such as a server for service notification.

The services using the service provided by the network, or the multifunction peripheral are not limited to electronic mail, FTP and SMB, and may include other services as well. Also multiple servers that can provide the services may be present in the same hotspot. For example, in the case where there a multiple electronic mail servers, the multifunction peripheral may be notified that all the servers are available, or the combined server may do checking, and the operation section displays the names of each of these servers as a list and then selects the server it wishes to use from among those displayed. This type of operation should be done by a serviceperson or someone with manger authority at the time of set up.

The timing for the inquiries by the multifunction peripheral 20 about the services available on the network may have various settings such as at setup time, the time when power is turned on, or at preset periods or times. In addition, the methods for making the user selection operation impossible are not limited to not displaying or graying out, but the functions may be displayed normally and when operated the operation is rejected and a rejection sound is generated.

Furthermore, in these embodiments, the example of a multifunction peripheral is described as the information processing apparatus, but other types of devices may be used provided that the device has a function realized by using a service provided from the network, or in other words the device may realize functions related to sending or receiving various data. For example a portable information terminal may also be used.

According to the information processing apparatus, network management apparatus and network system of this embodiment, inquiries about the services available on the network are sent to the management apparatus, but the information processing apparatus may check the services itself, and because the user selection operation is made impossible for functions using services which are unavailable on the network, these functions that cannot be used in the network environment of the setup location are automatically eliminated from the items selectable by the user, and operating properties are improved.

For those items which cannot be selected by the user which correspond to functions using network service for which use is not permitted, even if the service can be provided from the network, by changing the various settings of the permitted services, a security level corresponding to set up locations can be ensured. Furthermore, a user interface corresponding to the security level is automatically provided.

It is to be noted that various changes and modifications will be apparent to those skilled in the art. Therefore, unless such changes and modifications depart from the scope of the present invention, they should be construed as being included therein.

What is claimed is:

1. An information processing apparatus having function relating to data transmission and/or data reception, comprising:
a communication section connected to a management apparatus with a network, the management apparatus manages a service providing apparatus which provides a function relating to data transmission and/or data reception in the network;
a display section which displays the function relating to data transmission and/or data reception of the information processing apparatus; and
a control section which controls the communication section and the display section,
wherein the control section controls the communication section to receive an available information or a non-available information with regard to an available function or a non-available function of the service providing apparatus in the network, and controls the display section so that an available function of the information processing apparatus is selectable or a non-available function thereof is not selectable based on the available information or the non-available information.

2. The information processing apparatus of claim 1, wherein the available information or the non-available information is based on a security information of the network where the information processing apparatus located.

3. The information processing apparatus of claim 1, wherein the available information or the non-available information is based on a capability information for a service to be provided of the service providing apparatus in the network.

4. The information processing apparatus of claim 3, wherein the capability information is updated by a process that the management apparatus periodically checks a status of availability of the service providing apparatus.

5. The information processing apparatus of claim 4, wherein the capability information is updated by checking whether the service providing apparatus is connected with the management apparatus.

6. The information processing apparatus of claim 1, wherein the available information or the non-available information is based on a security information of the network where the information processing apparatus located and a capability information for a service to be provided of the service providing apparatus in the network.

7. The information processing apparatus of claim 1, wherein the management apparatus is equipped with the service providing apparatus.

8. The information processing apparatus of claim 1, wherein the service providing apparatus is a mail server, and the function relating to data transmission and/or data reception is a function for e-mail transmission and/or e-mail reception.

9. The information processing apparatus of claim 1, wherein the service providing apparatus is a FTP server, and the function relating to data transmission and/or data reception is a function for data transmission or data reception under FTP protocol.

10. The information processing apparatus of claim 1, wherein the service providing apparatus is a file server, and the function relating to data transmission and/or data reception is a function for data transmission and/or data reception under SMB protocol.

11. An information processing apparatus having a function relating to data transmission and/or data reception, comprising:
a communication section connected to a management apparatus with a network, the management apparatus manages a service providing apparatus which provides a function relating to data transmission and/or data reception in the network;
a display section which displays the function relating to data transmission and/or data reception of the information processing apparatus; and
a control section which controls the communication section and the display section,
wherein the control section controls the communication section to receive a security information of the network from the management apparatus, judges an available function relating to data transmission and/or data reception of the information processing apparatus and controls the display section so that an available function of the information processing apparatus is selectable or a non-available function thereof is not selectable based on the judgment.

12. The information processing apparatus of claim 11, wherein the control section controls the communication section to receive a capability information for a service to be provided or an incapability information with regard to a function of the service providing apparatus, and controls the display section based on the security information and the capability information or the incapability information.

13. The information processing apparatus of claim 11, further comprising:
a table which manages a relationship between the security information of the network and the available function relating to data transmission and/or data reception of the information processing apparatus,
wherein the control section judges the available function in accordance with the relationship of the table.

14. The information processing apparatus of claim 11, wherein the management apparatus is equipped with the service providing apparatus.

15. The information processing apparatus of claim 11, wherein the service providing apparatus is a mail server, and the function relating to data transmission and/or data reception is a function for e-mail transmission and/or e-mail reception.

16. The information processing apparatus of claim 11, wherein the service providing apparatus is a FTP server, and the function relating to data transmission and/or data reception is a function for data transmission and/or data reception under FTP protocol.

17. The information processing apparatus of claim 11, wherein the service providing apparatus is a file server, and the function relating to data transmission and/or data reception is a function for data transmission and/or data reception under SMB protocol.

18. An information processing apparatus having a function relating to data transmission and/or data reception, comprising:
a communication section connected to a service providing apparatus which provides a function relating to data transmission and/or data reception in the network with a network;
a display section which displays the function relating to data transmission and/or data reception of the information processing apparatus; and
a control section which controls the communication section and the display section,
wherein the control section controls the communication section to receive an available information or a non-available information with regard to an available function or a non-available function of the service providing apparatus in the network, and controls the display section so that an available function of the information processing apparatus is selectable or a non-available function thereof is not selectable based on the available information or the non-available information.

19. The information processing apparatus of claim 18, wherein the available information or the non-available information is based on a security information of the network where the information processing apparatus located.

20. The information processing apparatus of claim 18, wherein the available information or the non-available information is based on a capability information for a service to be provided of the service providing apparatus in the network where the apparatus located.

21. The information processing apparatus of claim 18, wherein the available information or the non-available information is based on a security information of the network where the information processing apparatus located and a capability information for a service to be provided of the service providing apparatus in the network.

22. The information processing apparatus of claim 18, wherein the service providing apparatus is a mail server, and the function relating to data transmission and/or data reception is a function for e-mail transmission and/or e-mail reception.

23. The information processing apparatus of claim 18, wherein the service providing apparatus is a FTP server, and the function relating to data transmission and/or data reception is a function for data transmission and/or data reception under FTP protocol.

24. The information processing apparatus of claim 18, wherein the service providing apparatus is a file server, and the function relating to data transmission and/or data reception is a function for data transmission and/or data reception under SMB protocol.

25. A management apparatus for managing a service providing apparatus which provides a function relating to data transmission and/or data reception in the network, the management apparatus is connected with an information processing apparatus including a display section which displays a function relating to data transmission and/or data reception of the information processing apparatus, and a control section which controls the display section so that an available function of the information processing apparatus is selectable or a non-available function thereof is not selectable based on an available information or a non-available information, comprising:
a communication section connected to the information processing apparatus with a network; and
a control section which controls the communication section to send the available information or the non-available information with regard to an available function or a non-available function of the service providing apparatus in the network in response to a request from the information processing apparatus.

26. The management apparatus of claim 25, wherein the available information or the non-available information is based on a security information of the network where the information processing apparatus located.

27. The management apparatus of claim 25, wherein the available information or the non-available information is based on a capability information for a service to be provided of the service providing apparatus in the network.

28. The management apparatus of claim 27, wherein the capability information is updated by a process that the management apparatus periodically checks a status of availability of the service providing apparatus.

29. The management apparatus of claim 28, wherein the capability information is updated by checking whether the service providing apparatus is connected with the management apparatus.

30. The management apparatus of claim 25, wherein the available information or the non-available information is based on a security information of the network where the information processing apparatus located and a capability information for a service to be provided of the service providing apparatus in the network.

31. The management apparatus of claim 25, wherein the management apparatus is equipped with the service providing apparatus.

32. The management apparatus of claim 25, wherein the service providing apparatus is a mail server, and the function relating to data transmission and/or data reception is a function for e-mail transmission and/or e-mail reception.

33. The management apparatus of claim 25, wherein the service providing apparatus is a FTP server, and the function relating to data transmission and/or data reception is a function for data transmission and/or data reception under FTP protocol.

34. The management apparatus of claim 25, wherein the service providing apparatus is a file server, and the function relating to data transmission and/or data reception is a function for data transmission and/or data reception under SMB protocol.

35. A management apparatus for managing a service providing apparatus which provides a function relating to data transmission and/or data reception in the network, the management apparatus is connected with an information processing apparatus including a display section which displays a function relating to data transmission and/or data reception of the information processing apparatus, and a control section which controls the display section so that an available function of the information processing apparatus is selectable or a non-available function thereof is not selectable based on a security information the network, comprising:
a communication section connected to the information processing apparatus with a network; and
a control section which controls the communication section to send the security information of the network in response to a request from the information processing apparatus.

36. The management apparatus of claim 35, wherein the control section controls the communication section to send a capability information for a service to be provided or a incapability information with regard to a function of the service providing apparatus.

37. The management apparatus of claim 35, wherein the management apparatus is equipped with the service providing apparatus.

38. The management apparatus of claim 35, wherein the service providing apparatus is a mail server, and the function relating to data transmission and/or data reception is a function for e-mail transmission and/or e-mail reception.

39. The management apparatus of claim 35, wherein the service providing apparatus is a FTP server, and the function relating to data transmission and/or data reception is a function for data transmission and/or data reception under FTP protocol.

40. The management apparatus of claim 35, wherein the service providing apparatus is a file server, and the function relating to data transmission and/or data reception is a function for data transmission and/or data reception under SMB protocol.

41. A network system, comprising:
an information processing apparatus which has a function relating to data transmission and/or data reception; and
a management apparatus which manages a service providing apparatus providing a function relating to data transmission and/or data reception in the network,
wherein the information processing apparatus comprises
a first communication section connected to the management apparatus with a network;
a display section which displays the function relating to data transmission and/or data reception of the information processing apparatus; and
a first control section which controls the first communication section and the display section,
wherein the first control section controls the first communication section to receive an available information or a non-available information with regard to an available function or a non-available function of the service providing apparatus in the network, and controls the display section so that an available function of the information processing apparatus is selectable or a non-available function thereof is not selectable based on the available information or the non-available information,
wherein the management apparatus comprises
a second communication section connected to the information processing apparatus with a network; and
a second control section which controls the second communication section to send the available information or the non-available information in response to a request from the information processing apparatus.

42. A network system, comprising:
an information processing apparatus which has a function relating to data transmission and/or data reception; and
a management apparatus which manages a service providing apparatus providing a function relating to data transmission and/or data reception in the network,
wherein the information processing apparatus comprises
a first communication section connected to the management apparatus with a network;
a display section which displays the function relating to data transmission and/or data reception of the information processing apparatus; and
a first control section which controls the first communication section and the display section,
wherein the first control section controls the first communication section to receive a security information of the network from the management apparatus, judges an available function relating to data transmission and/or data reception of the information processing apparatus and controls the display section so that an available function of the information processing apparatus is selectable or a non-available function thereof is not selectable based on the judgment,
wherein the management apparatus comprises
a second communication section connected to the information processing apparatus with a network; and
a second control section which controls the second communication section to send the security information of the network in response to a request from the information processing apparatus.
